(19) United States
(12) Patent Application Publication
(10) Pub. No.: US 2024/0362543 A1
(43) Pub. Date: Oct. 31, 2024

(54) LEARNING DEVICE, LEARNING METHOD, AND RECORDING MEDIUM

(71) Applicant: NEC Corporation, Minato-ku, Tokyo (JP)

(72) Inventor: Shuhei Yoshida, Tokyo (JP)

(73) Assignee: NEC Corporation, Minato-ku, Tokyo (JP)

(21) Appl. No.: 18/690,289

(22) PCT Filed: Sep. 27, 2021
(86) PCT No.: PCT/JP2021/035277

§ 371 Date: Mar. 8, 2024

(51) Int. Cl. G06N 20/00

(52) U.S. Cl. CPC G06N 20/00

(57) ABSTRACT

In a learning device, an inference means performs an inference with respect to training data using an inference model, and outputs a class score. A weight calculation means calculates each weight using a weight function which rapidly increases faster than a linear function for the class score that is over-estimated or under-estimated, based on output the class score. A weight sum calculation means calculates a total of weights over a mini-batch included in a predetermined number of training data. A regularization term calculation means calculates a regularization term by applying a rescale function which is a monotonically increasing function gradually increasing more than a linear function, to the regularization term. An optimization means optimizes the inference model using a total loss including the regularization term.

### TECHNICAL FIELD

The present disclosure relates to a learning device, a learning method, and a recording medium.

### BACKGROUND ART

In a case of training a large-scale machine learning model such as deep learning, it is known that a regularization is used to suppress overtraining. For instance, Patent Document 1 discloses a technique for updating weight parameters of a neural network using a cost function obtained by adding a regularization term to an error function.

### PRECEDING TECHNICAL REFERENCES

### Patent Document

Patent Document 1: Japanese Laid-open Patent Publication No. 2021-43596

### SUMMARY

### Problem to be Solved by the Invention

In a conventional technique, a regularization has been uniformly carried out for all training data. For this reason, the regularization becomes weaker for simple training data to be predicted, which thus causes overfitting, or the regularization becomes stronger for training data that are difficult to predict, which thus reduces efficiency of learning.

It is one object of the present disclosure to adaptively control the strength of the regularization in deep learning depending on the training data.

### Means for Solving the Problem

According to an example aspect of the present disclosure, there is provided a learning device including:
an inference means configured to perform an inference with respect to training data using an inference model, and to output a class score;
a weight calculation means configured to calculate each weight using a weight function which rapidly increases faster than a linear function for the class score being over-estimated or under-estimated, based on the class score being output;
a weight sum calculation means configured to calculate a sum of weights over a mini-batch included in a predetermined number of training data;
a regularization term calculation means configured to calculate a regularization term by applying a rescale function, which is a monotonically increasing function gradually increasing more than a linear function, to the regularization term; and
an optimization means configured to optimize the inference model using a total loss including the regularization term.

According to another example aspect of the present disclosure, there is provided a learning method including:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.

According to still another example aspect of the present disclosure, there is provided a recording medium storing a program, the program causing a computer to perform a process including:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.

### Effect of the Invention

According to the present disclosure, it becomes possible to adaptively control a strength of a regularization in deep learning depending on training data.

### BRIEF DESCRIPTION OF THE DRAWINGS

FIG. 1 is a block diagram illustrating a hardware configuration of a learning device of a first example embodiment.

FIG. 2 is a block diagram illustrating a functional configuration of the learning device of the first example embodiment.

FIG. 3 illustrates examples of a weight function and a rescale function.

FIG. 4 is a flowchart of a learning process in the learning device of the first example embodiment.

FIG. 5 is a block diagram illustrating a functional configuration of a learning device of a second example embodiment.

FIG. 6 is a flowchart of a learning process in the learning device of the second example embodiment.

### EXAMPLE EMBODIMENTS

In the following, preferable example embodiments will be described with reference to the accompanying drawings.

### First Example Embodiment

### [Learning Device]

### (Hardware Configuration)

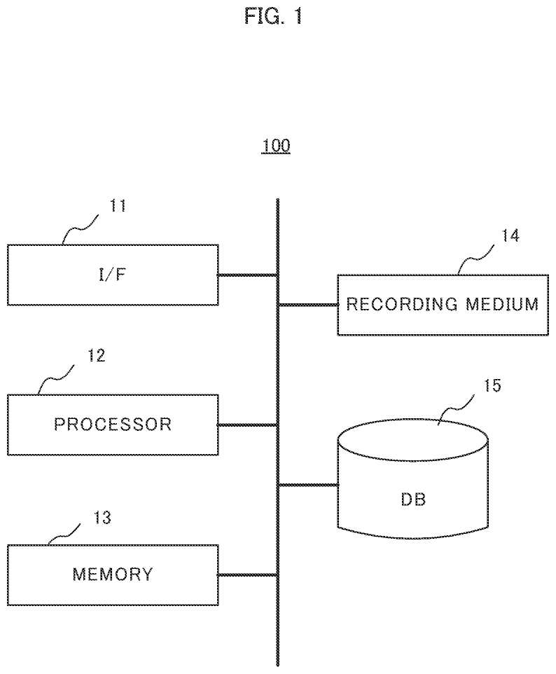

FIG. 1 is a block diagram illustrating a hardware configuration of a learning device 100 according to the first example embodiment. As illustrated, the learning device 100 includes an interface (I/F) 11, a processor 12, a memory 13, a recording medium 14, and a database (DB) 15.

The interface 11 inputs and outputs data to and from an external device. Specifically, training data set used for learning are input to the learning device 100 through the interface 11.

The processor 12 is a computer such as a CPU (Central Processing Unit), and controls the entire learning device 100 by executing a predetermined program. The processor 12 may be a GPU (Graphics Processing Unit) or a FPGA (Field-Programmable Gate Array). The processor 12 executes a learning process to be described later.

The memory 13 consist of a ROM (Read Only Memory) and a RAM (Random Access Memory). The memory 13 is also used as a working memory during operations of various processes by the processor 12.

The recording medium 14 is a non-volatile and non-transitory recording medium such as a disk-shaped recording medium, a semiconductor memory, or the like, and is formed to be detachable to the learning device 100. The recording medium 14 records various programs to be executed by the processor 12. When the learning device 100 executes various types of processes, each program recorded in the recording medium 14 is loaded into the memory 13 and executed by the processor 12. The DB 15 stores the training data set entered through the interface I/F 11 as needed.

### (Function Configuration)

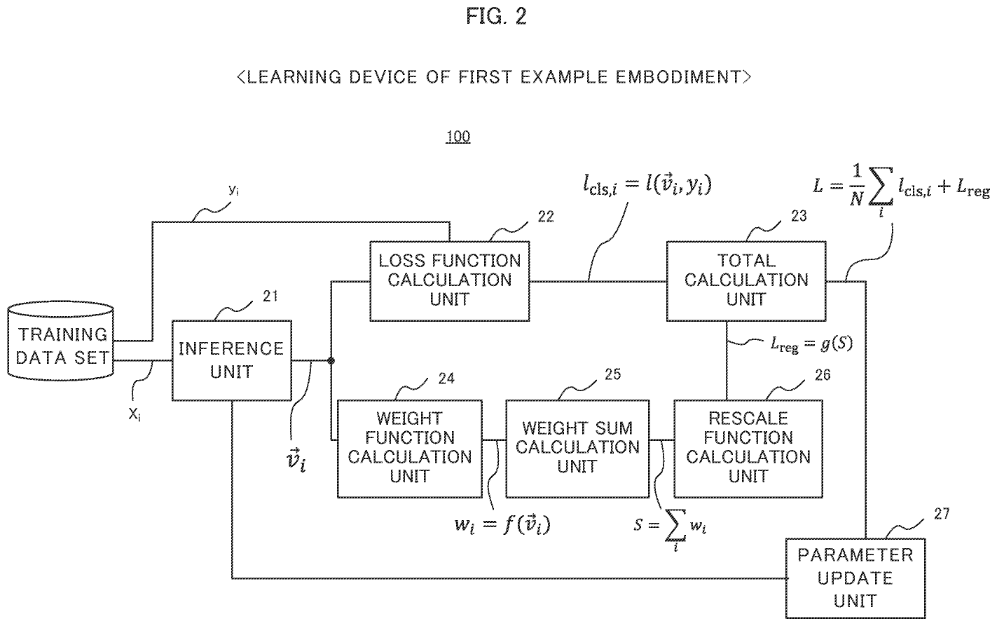

FIG. 2 is a block diagram illustrating a functional configuration of the learning device 100 according to the first example embodiment. The learning device 100 includes an inference unit 21, a loss function calculation unit 22, a total calculation unit 23, a weight function calculation unit 24, a weight sum calculation unit 25, a rescale function calculation unit 26, and a parameter update unit 27.

The training data set is input to the learning device 100. The training data set includes a plurality of training data xᵢ and correct answer class yᵢ corresponding to the respective training data xᵢ. The training data xᵢ is input to the inference unit 21, and the correct answer class yᵢ is input to the loss function calculation unit 22.

The inference unit 21 performs inference using a deep learning model to be trained by the learning device 100. Specifically, the inference unit 21 includes a neural network which forms the deep learning model to be learned. The inference unit 21 performs an inference for training data xᵢ being input, and outputs each class score v^{->}ᵢ as the inference result. In detail, the inference unit 21 performs a class classification for the training data xᵢ, and outputs each class score v^{->}ᵢ which is a vector indicating a reliability score for each class. In this disclosure, for convenience, “->” indicating the vector is denoted by a superscript on a right side of “v”. Each class score v^{->}ᵢ is input to the weight function calculation unit 24.

The loss function calculation unit 22 calculates a loss l_{cls,i} for each class score v^{->}ᵢ using a loss function prepared in advance. Specifically, the loss function calculation unit 22 calculates the loss l_{cls,i} using the class score v^{->}ᵢ for certain training data xᵢ and a correct answer class yᵢ for the training data xᵢ as illustrated in an equation (1). The calculated lost l_{cls,i} is input to the total calculation unit 23.

$$\begin{matrix}[ Math 1 ] & \\ {l}_{cls , i} = l ( {\vec{v}}_{i} , {y}_{i} ) & ( 1 )\end{matrix}$$

Meanwhile, the weight function calculation unit 24 calculates a weight for the training data xᵢ based on the class score v^{->}ᵢ generated by the inference unit 21. Specifically, the weight function calculation unit 24 determines each weight wᵢ which is a single real value by the following equation (2) from the class score v^{->}ᵢ which is an inference result for the training data xᵢ.

$$\begin{matrix}[ Math 2 ] & \\ {w}_{i} = f ( {\vec{v}}_{i} ) & ( 2 )\end{matrix}$$

As a weight function, a rapidly increasing function is chosen in a case where a confidence score of each of classes included in the class score v^{->}ᵢ is over-estimated or under-estimated. The term “rapidly” means faster than a linear function. The condition that the weight function increases rapidly is necessary to emphasize the over-confidence score or under-confidence score included in the class score v^{->}ᵢ. That is, by calculating each weight using the rapidly increasing function, in a case where the class score v^{->}ᵢ includes a value of the over-confidence score or under-confidence score, the over or under value is emphasized and each weight wᵢ becomes larger. Accordingly, this means that the selection of the weight function determines a contribution of each weight for the training data to a gradient of a regularization term discussed later, which will be described later. Note that since the weight function calculation unit 24 simply outputs a result in which a reliability score of each class included in the class score v^{->}ᵢ is input into the weight function, the value of each weight wᵢ to be output is not a particularly regularized value. The weight function calculation unit 24 outputs the calculated weight w; to the weight sum calculation unit 25.

The weight sum calculation unit 25 calculates a total of the weights wᵢ for a mini-batch. The mini-batch is a set of a predetermined number (for instance, N count) of training data. Specifically, the weight sum calculation unit 25 calculates a sum S of a N count of weights wᵢ corresponding to the N count of the training data xᵢ by the following equation (3).

$$\begin{matrix}[ Math 3 ] & \\ S = {\sum }_{i} {w}_{i} & ( 3 )\end{matrix}$$

The weight sum calculation unit 25 outputs the calculated sum S to the rescale function calculation unit 26.

The rescale function calculation unit 26 calculates a rescale function, and generates a regularization term L_{reg} based on the sum S being input. Specifically, the rescale function calculation unit 26 generates the regularization term L_{reg} by the following equation (4).

$$\begin{matrix}[ Math 4 ] & \\ {L}_{reg} = g ( S ) & ( 4 )\end{matrix}$$

In the equation (4), “g(S)” is the rescale function. As the rescale function g(S), a monotonically increasing function that increases gradually is chosen. Note that this monotonically increasing function that increases gradually is different from a mathematical “slow increasing function”.

Here, “gradually” means slower than a linear function. The condition that the rescale function g(S) is gradual is necessary to prevent the rapidly increasing weight function from increasing the gradient of the regularization term and thus making the learning unstable. In other words, because regularization may be too strong when using the weighted wᵢ as it is in which the over-confidence score or under-confidence score due to the weight function is emphasized, the rescale function g(S) is used to adjust the whole scale of the weight wᵢ. In this regard, the rescale function g(S) can also be regarded as regularizing the weight wᵢ and adjusting the strength of the overall regularization. The rescale function calculation unit 26 outputs the regularization term L_{reg} thus obtained to the total calculation unit 23.

The total calculation unit 23 calculates a total (hereinafter, also referred to as a “total loss L”) of the loss l_{cls,i} input from the loss function calculation unit 22 and the regularization term L_{reg} input from the rescale function calculation unit 26. Specifically, the total calculation unit 23 calculates the total loss L by dividing a value where a total of the loss l_{cls,i} and the regularization term L_{reg} are added up over a count 1 of the training data, by a count N of the training data included in the mini-batch by the following equation (5).

$$\begin{matrix}[ Math 5 ] & \\ L = \frac{1}{N} {\sum }_{i} {l}_{cls , i} + {L}_{reg} & ( 5 )\end{matrix}$$

Then, the total calculation unit 23 outputs the obtained total loss L to the parameter update unit 27.

The parameter update unit 27 optimizes the inference unit 21 based on the input total loss L. Specifically, the parameter update unit 27 updates parameters of the neural network forming the inference unit 21 based on the total loss L. Thus, the learning of the deep learning model constituting the inference unit 21 is performed.

As described above, according to the learning device 100 of the first example embodiment, the contribution to the regularization term of each training data can be adaptively determined by calculating the regularization term in unit of the mini-batch. Moreover, by emphasizing the over or under inference result output by the inference unit 21 using the weight function, it is possible for the learning device 100 to prevent overfitting by strengthening the regularization for easy training data and to improve learning efficiency by weakening the regularization for difficult training data. Furthermore, by adjusting the whole scale of weights using the rescale function, it is possible for the learning device 100 to regularize the weights being partially emphasized by the weight function and to adjust the strengthen of the overall regularization. As a result, it becomes possible to adaptively determine the strength of the regularization depending on the training data and obtain a higher generalization performance, that is, a classification accuracy.

In the configuration described above, the inference unit 21 corresponds to an example of an inference unit, the loss function calculation unit 22 corresponds to an example of a loss calculation unit, the weight function calculation unit 224 corresponds to an example of a weight calculation unit, the weight sum calculation unit 25 corresponds to an example of a weight calculation unit, the rescale function calculation unit 26 corresponds to an example of a regularization term calculation unit, and the parameter update unit 27 corresponds to an example of an optimization unit.

### Functional Example

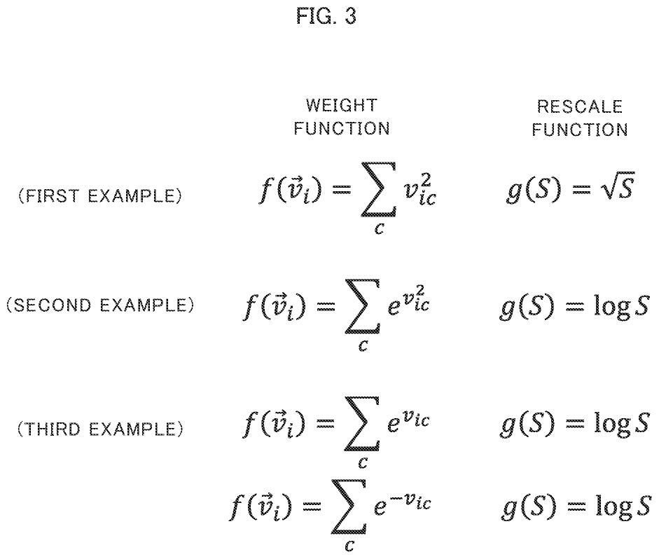

FIG. 3 illustrates examples of the weight function and the rescale function. In a first example, the weight function is a function which adds up squares of respective confidence scores vᵢₑ of classes included in the class score v^{->}ᵢ over a count c of all classes. Moreover, the rescale function is a function for calculating a square root of the sum S to be output by the weight sum calculation unit 25.

In a second example, the weighting function is a function which adds up natural logarithms of the squares of the confidence scores vᵢₑ of classes included in the class score v^{->}ᵢ over the count c of all classes. Also, the rescale function is a function which calculates a logarithm of the sum S which the weight sum calculation unit 25 outputs.

In a third example, the weight function is a function which adds up natural logarithms of positive and negative confidence scores vᵢₑ of the classes included in the class score v^{->}ᵢ over the count c of all classes. The rescale function is a function which calculates the logarithm of the sum S which the weight sum calculation unit 25 outputs.

### (Learning Process)

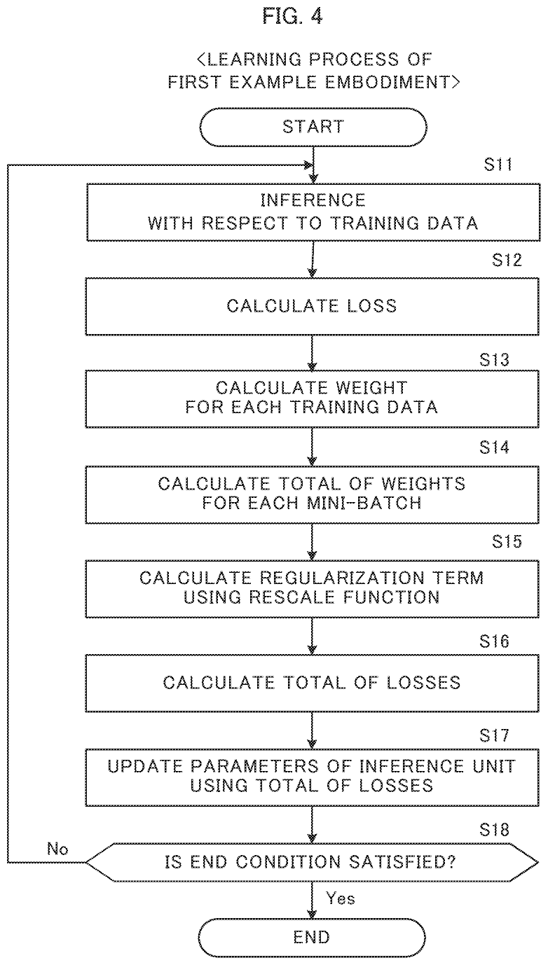

FIG. 4 is a flowchart of the learning process performed by the learning device 100. This process is realized by the processor 12 illustrated in FIG. 1 which executes programs prepared in advance and operates as each element illustrated in FIG. 2.

First, the inference unit 21 performs the inference for the input training data xᵢ (step S11). The inference unit 21 outputs the class score v^{->}ᵢ obtained by the inference to the loss function calculation unit 22 and the weight function calculation unit 24. Based on the class score v^{->}ᵢ, the loss function calculation unit 22 calculates the loss l_{cls,i} using the equation (1), and outputs the loss l_{cis,i} to the total calculation unit 23 (step S12).

Next, based on the class score v^{->}ᵢ, the weight function calculation unit 24 calculates the weight wᵢ using the equation (2), and outputs the weight wᵢ to the weight sum calculation unit 25 (step S13). Next, the weight sum calculation unit 25 calculates the sum S of the weights wᵢ for each mini-batch by the equation (3), and outputs the sum S for each mini-batch to the rescale function calculation unit 26 (step S14). Next, the rescale function calculation unit 26 calculates the regularization term L_{reg} from the sum S being input using the rescale function, and outputs the total calculation unit 23 (step S15). Note that the process of step S12 and the processes of steps S13 to S15 may be performed in a reverse order or in parallel in time.

Next, based on the regularization term L_{reg} input from the rescale function calculation unit 26 and the loss l_{cls,i} input from the loss function calculation unit 22, the total calculation unit 23 calculates a total of losses (total loss L) using the equation (5), and outputs the total loss L to the parameter update unit 27 (step S16). Next, the parameter update unit 27 updates the parameters of the neural network forming the inference unit 21 based on the total of the losses (total loss L) (step S17).

Next, it is determined whether or not an end condition of the learning is satisfied (step S18). As the end condition, for instance, it is possible to use that all training data have been used, that an accuracy of the inference unit 21 has reached a predetermined accuracy, or the like. When the end condition has not been satisfied (step S18: No), the learning process returns to step S11, and the process of steps S1 to S17 are thus performed using next training data. On the other hand, when the end condition is satisfied (S18: Yes), the learning process is terminated.

### Second Example Embodiment

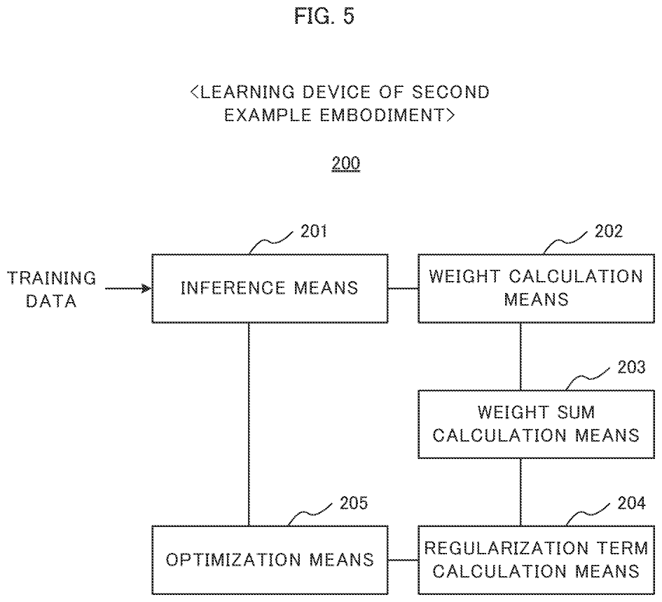

FIG. 5 is a block diagram illustrating a functional configuration of a learning device according to a second example embodiment. The learning device 200 includes an inference means 201, a weight calculation means 202, a weight sum calculation means 203, a regularization term calculation means 204, and an optimization means 205.

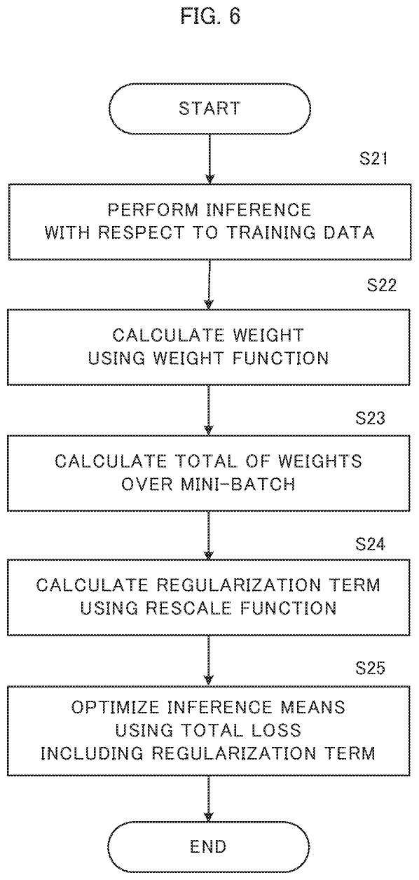

FIG. 6 is a flowchart of a learning process performed by the learning device 200 according to the second example embodiment. First, the inference means 201 performs the inference with respect to training data, and outputs a class score (step S21). Next, the weight calculation means 202 calculates each weight based on the class score output by the inference means 201 using the weight function which rapidly increases faster than a linear function in a case of the over-confidence score or under-confidence score (step S22). Next, the weight sum calculation means 203 calculates the total of weights over the mini-batch including a predetermined number of the training data (step S23). Next, the regularization term calculation means 204 applies the rescale function which is a monotonically increasing function which increases gradually more than a linear function, to the total, and thus calculates the regularization term (step S24). After that, the optimization means 205 optimizes the inference means using the loss including the regularization term (step S25).

According to the learning device 200 of the second example embodiment, in the deep learning, it becomes possible to adaptively control the strength of the regularization depending on the training data.

A part or all of the example embodiments described above may also be described as the following supplementary notes, but not limited thereto.

### (Supplementary Note 1)

A learning device comprising:
an inference means configured to perform an inference with respect to training data using an inference model, and to output a class score;
a weight calculation means configured to calculate each weight using a weight function which rapidly increases faster than a linear function for the class score being over-estimated or under-estimated, based on the class score being output;
a weight sum calculation means configured to calculate a total of weights over a mini-batch included in a predetermined number of training data;
a regularization term calculation means configured to calculate a regularization term by applying a rescale function, which is a monotonically increasing function gradually increasing more than a linear function, to the regularization term; and
an optimization means configured to optimize the inference model using a total loss including the regularization term.

### (Supplementary Note 2)

The learning device according to supplementary note 1, wherein the regularization term calculation means increases a value of the regularization term for the class score that is high, and decreases the value of the regularization term for the class score that is low.

### (Supplementary Note 3)

The learning device according to supplementary note 1 or 2, further comprising a loss calculation means configured to calculate a loss based on the class score and a correct answer class corresponding to the training data,
wherein the class score is a total of the loss and the regularization term.

### (Supplementary Note 4)

The learning device according to supplementary note 1, wherein
the class score includes a confidence score for each class with respect to one training data,
the weight function is a function which adds up a scare of the confidence score of each class over all classes, and
the rescale function is a function which calculates a square root of the total.

### (Supplementary Note 5)

The learning device according to supplementary note 1, wherein
the class score includes a confidence score of one training data,
the weight function is a function which adds up a natural logarithm of a square of the confidence score for each class over all classes, and
the rescale function is a function which calculates a logarithm of the total.

### (Supplementary Note 6)

The learning device according to any one of supplementary notes 1 to 3, wherein
the class score includes a confidence score for each class with respect to one training data;
the weight function is a function which adds up a natural logarithm of the confidence score for each class, and
the rescale function is a function which calculates a logarithm of the total.

### (Supplementary Note 7)

A learning method comprising:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.

### (Supplementary Note 8)

A recording medium storing a program, the program causing a computer to perform a process comprising:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21 Inference unit
22 Loss function calculation unit
23 Total calculation unit
24 Weight function calculation unit
25 Weight sum calculation unit
26 Rescale function calculation unit
27 Parameter update unit
100, 200 Learning device

What is claimed is:

1. A learning device comprising:
a memory storing instructions; and
one or more processors configured to execute the instructions to:
perform an inference with respect to training data using an inference model, and to output a class score;
calculate each weight using a weight function which rapidly increases faster than a linear function for the class score being over-estimated or under-estimated, based on the class score being output;
calculate a total of weights over a mini-batch included in a predetermined number of training data;
calculate a regularization term by applying a rescale function, which is a monotonically increasing function gradually increasing more than a linear function, to the regularization term; and
optimize the inference model using a total loss including the regularization term.

2. The learning device according to claim 1, wherein the processor increases a value of the regularization term for the class score that is high, and decreases the value of the regularization term for the class score that is low.

3. The learning device according to claim 1, wherein processor is further configured to calculate a loss based on the class score and a correct answer class corresponding to the training data,
wherein the class score is a total of the loss and the regularization term.

4. The learning device according to claim 1, wherein
the class score includes a confidence score for each class with respect to one training data,
the weight function is a function which adds up a scare of the confidence score of each class over all classes, and
the rescale function is a function which calculates a square root of the total.

5. The learning device according to claim 1, wherein
the class score includes a confidence score of one training data,
the weight function is a function which adds up a natural logarithm of a square of the confidence score for each class over all classes, and
the rescale function is a function which calculates a logarithm of the total.

6. The learning device according to claim 1, wherein
the class score includes a confidence score for each class with respect to one training data;
the weight function is a function which adds up a natural logarithm of the confidence score for each class, and
the rescale function is a function which calculates a logarithm of the total.

7. A learning method comprising:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.

8. A non-transitory computer readable recording medium storing a program, the program causing a computer to perform a process comprising:
performing an inference with respect to training data using an inference model, and outputting a class score;
calculating each weight using a weight function which rapidly increases faster than a linear function for the class score being over-estimated or under-estimated, based on the class score being output;
calculating a total of weights over a mini-batch included in a predetermined number of training data;
calculating a regularization term by applying a rescale function, which is a monotonically increasing function gradually increasing more than a linear function, to the regularization term; and
optimizing the inference model using a total loss including the regularization term.
